(19) United States
(12) Patent Application Publication
(10) Pub. No.: US 2005/0282921 A1
(43) Pub. Date: Dec. 22, 2005

(54) AUTOMOTIVE GRADE, FLEXIBLE POLYURETHANE FOAM AND METHOD FOR MAKING THE SAME

(75) Inventors: Cynthia Flanigan, Canton, MI (US); Deborah Mielewski, Ann Arbor, MI (US); Christine Perry, Gibraltar, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/160,279

(22) Filed: Jun. 16, 2005

Related U.S. Application Data
(60) Provisional application No. 60/581,318, filed on Jun. 18, 2004.

(51) Int. Cl. C08J 9/00

(52) U.S. Cl. 521/99

(57) ABSTRACT

The present invention, in at least certain aspects, provides a cellular material, a method of making cellular material, and a composition for making the cellular material. The cellular material comprises the reaction product of soy-based polyol, petro-based blowing agent, cross-linking agent, a combination of silicone surfactants and isocyanate.

### CROSS-REFERENCE TO RELATED APPLICATIONS

This application claims the benefit of U.S. provisional application Ser. No. 60/581,318 filed Jun. 18, 2004.

### BACKGROUND OF THE INVENTION

1. Field of the Invention

The present invention relates to soy-based flexible polyurethane foam, especially suited for automobile interior applications, and method for making the same.

2. Background Art

Flexible, polyurethane foams have been extensively used in the automotive industry for applications such as seating, soft instrument panels, armrest and headrests and head liners. On average, 35 pounds of flexible foam are used per vehicle.

The production of urethane foams are well known in the art. Urethanes are formed when isocyanate (NCO) groups react with hydroxyl (OH) groups. The most common method of urethane production is via the reaction of polyol and isocyanate which forms the backbone urethane group.

A blowing agent is added to the reaction to cause gas or vapor to be evolved during the reaction. The blowing agent creates the void cells in the final foam, and commonly is a solvent with a relatively low boiling point or water. As the urethane reaction proceeds and the material solidifies, the vapor gas bubbles from the blowing agent are locked into place to form void cells. The final urethane foam density and rigidity may be controlled by varying the amount or type of blowing agent used.

Other conventional components such as cross-linking agents and catalysts are often used in standard foam formulations. A cross-linking agent promotes chemical cross-linking to result in a structured final urethane product. The catalyst controls reaction kinetics to help tailor the final product qualities.

A polyol commonly used in the polyurethane foam reactions are typically derived from petrochemicals, such as glycerin and ethylene oxide. The use of petrochemical polyols is a variety of reasons. First, since petrochemicals are derived from petroleum, they are a non-renewable resource. Furthermore, the production of a polyol may require a great deal of energy and expense, as oil must be drilled, extracted from the ground, transported to refineries, refined, and otherwise processed to yield the polyol.

With uncertainties in the long-term economic stability and limited reserves of fossil fuels and oils, investigations into using renewable resources as a source for foams have been ongoing. As part of that investigation, soy-based polyols have been developed as an alternative to petroleum-based polyols. The soy-based polyols are considered a good alternative to petroleum-based polyols for the production of polyurethane since the soy-based material can offer cost advantages as well as alleviate the environmental concerns associated with petroleum-based polyols. Examples of the use of soy-based polyols to formulate soy-based polyurethane foams can be found in U.S. Patent Application Nos. 2002/009230, 2002/0192456, 2003/0083394 and U.S. Pat. Nos. 5,710,190 and 6,624,244.

While soy-based polyurethane foams have made inroads into various polyurethane foam markets, the use of soy-based polyurethane foam has not gained acceptance in the automotive industry. Primarily, this is because soy-based polyurethane foams have not been able to meet the stringent specification requirements for use in automotive interior components. Among the automotive interior specification requirements are that the polyurethane foam must have a density of at least 35 kilograms/m³, a compression set at 50 percent deflection of less than 14 percent, a tensile strength greater than 110 kPa, an elongation of greater than 95 percent and a tear resistance greater than 170 N/m. It is also desirable for the foam to meet certain fogging (such as above 90 as measured by SAE J 1756, 3 hour at 100° C.) and/or odor (such as two or less as measured by SAE J 1351 at 65° C.) requirements.

Accordingly, it is desirable and there is a need to provide a soy-based polyurethane foam that can meet the stringent specification requirements for use in the automotive industry.

### SUMMARY OF THE INVENTION

One aspect of the present invention relates to a cellular material. In certain embodiments, the cellular material includes the reaction product of soy-based polyol, conventional polyols, blowing agent, cross-linker, a combination of silicone surfactants and isocyanate.

In another aspect of the present invention, the present invention relates to a method of making a cellular material. The method may include reacting soy-based polyol, conventional polyols, blowing agent, cross-linker, a combination of silicone surfactants and isocyanate together.

In yet another aspect of the present invention, the present invention relates to a composition suitable for making the cellular material. The composition may include conventional polyols, soy-based polyol, blowing agent, cross-linker, a combination of silicone surfactants and isocyanate.

In at least one aspect of the present invention, catalyst is provided to speed up and/or control the reaction kinetics of the components.

In at least one aspect of the present invention, conventional polyols, such as petrochemical-based polyols are provided.

In at least one aspect of the present invention, the combination of silicone surfactants is provided in an amount such that the resultant cellular material has a density of greater than 35 kilograms/m³, a compression set at 50 percent deflection of less than 14 percent, a tensile strength of greater than 110 kPa, an elongation of greater than 95 percent and a tear resistance of at least 170 N/m.

According to another aspect of the present invention, the resultant cellular material has a density of greater than 45 kilograms/m³, a compression set at 75 percent deflection of less than 25 percent, a tensile strength of greater than 80 kPa, an elongation of greater than 80 percent, and a tear resistance of at least 180 N/m.

In at least another aspect, the polyol may include a vegetable or seed, nut or plant oil.

In at least one aspect, the vegetable oil is selected from the group consisting of soy oil, rapeseed oil, sunflower oil, cotton seed oil and palm oil. In at least one aspect, the vegetable oil comprises blown soy oil.

In at least one aspect, the combination of silicone surfactants comprises a first surfactant comprising a silicone glycol copolymer.

In at least another aspect, the combination of silicone surfactants comprises a second silicone surfactant.

In at least one aspect, the components are present in the following amounts, based on the total weight of the composition:

| Components | wt. % |
|---|---|
| soy-based polyol | 5-75 |
| petrochemical-based polyol | 0-50 |
| blowing agent | 0.5-5.0 |
| cross-linker | 0.05-5.0 |
| first silicone surfactant | 0.005-0.25 |
| second silicone surfactant | 0.1-4.75 |
| catalyst blend | 0-5.0 |
| isocyanate | 25-75 |

In at least another aspect of the present invention, the components are present in the following amounts, based on the total weight of the composition:

| Components | wt. % |
|---|---|
| soy-based polyol | 10-40 |
| petrochemical-based polyol | 15-50 |
| blowing agent | 1-3 |
| cross-linker | 0.1-0.5 |
| first silicone surfactant | 0.01-0.1 |
| second silicone surfactant | 0.5-1.5 |
| catalyst | 0.5-1.5 |
| isocyanate | 35-65 |

In yet another aspect of the present invention, the components are present in the following amounts, based on the total weight of the composition:

| Components | wt. % |
|---|---|
| soy-based polyol | 18 |
| petrochemical-based polyol | 28.7 |
| blowing agent | 1.7 |
| cross-linker | 0.17 |
| first silicone surfactant | 0.03 |
| second silicone surfactant | 0.7 |
| catalyst | 0.7 |
| isocyanate | 50 |

In at least one embodiment, the present invention comprises a cellular material comprising the reaction product of:
soy-based polyol;
blowing agent;
cross-linker;
a combination of silicone surfactants; and
isocyanate.

The cellular material may also include a petroleum-based polyol.

In at least one embodiment, the present invention comprises a method of making a cellular material, the method comprises reacting the following components together:
soy-based polyol;
blowing agent;
cross-linker;
a combination of silicone surfactants; and
isocyanate.

In at least one embodiment, the present invention comprises a composition suitable for making a cellular material, the composition comprising:
soy-based polyol;
blowing agent;
cross-linker;
a combination of silicone surfactants; and
isocyanate.

In at least one embodiment, the combination of silicone surfactants is provided in an amount such that the cellular material has a density of greater than 35 kilograms/m³, a compression set at 50 percent deflection of less than 14 percent, a tensile strength of greater than 110 kPa, an elongation of greater than 95 percent and a tear resistance of at least 170 N/m.

In another embodiment, the cellular material has a density of greater than 45 kilograms/m³, a compression set at 75 percent deflection of less than 25 percent, a tensile strength of greater than 80 kPa, an elongation of greater than 80 percent, and a tear resistance of at least 180 N/m.

In at least one embodiment, the combination of silicone surfactants comprises a first surfactant comprising a silicone glycol copolymer.

In at least one embodiment, the combination of silicone surfactants comprises a second silicone surfactant.

In at least one embodiment, the soy-based polyol comprises a vegetable oil.

In at least one embodiment, the vegetable or plant or nut oil is selected from the group consisting of soy oil, rapeseed oil, cotton seed oil, sunflower oil and palm oil.

In at least one embodiment, the vegetable oil comprises blown soy oil.

In at least one embodiment, the present invention comprises the components of the composition present in the following amounts, based upon the total weight of the composition:

| Components | wt. % |
|---|---|
| soy-based polyol | 5-75 |
| petroleum-based polyol | 15-50 |
| blowing agent | 0.5-5.0 |
| cross-linker | 0.05-5.0 |
| first silicone surfactant | 0.005-0.25 |
| second silicone surfactant | 0.1-4.75 |
| isocyanate | 25-75 |

### DETAILED DESCRIPTION

As required, detailed embodiments of the present invention are disclosed herein. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ aspects of the present invention. Moreover, except for otherwise expressly indicated, all numeral quantities in this description indicating amounts of material are to be understood as modified the word “about” in describing the broadest scope of the invention. Practice within the numerical limit stated is generally preferred.

Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with at least one aspect of the invention implies that mixtures of any two or more of the members of the group or class are equally suitable; description of constituents in chemical terms refers to the constituents at the time of addition to any combination specified in the description, and does not necessarily preclude chemical interactions among the constituents of a mixture once mixed; and the first definition of an acronym or other abbreviation applies to all subsequent uses herein of the same abbreviation and applies mutatis mutandis to normal grammatical variations of the initially defined abbreviation.

The present invention relates to making a cellular material, such as polyurethane foam. The polyurethane foam can be prepared by reacting what is known in the art as an A-side reactant with what is known as a B-side reactant. The A-side reactant is generally considered to include an isocyanate, such as diisocyanate, or a mixture of, isocyanates. The diisocyanates typically used are diphenylmethane diisocyanate (MDI) or toluenediisocyanate (TDI). Of course it should be understood that the particular isocyanates chosen will depend upon the particular final physical properties desired in the urethane.

The B-side reactant generally comprises a solution of isocyanate-reactive component, such as polyether polyol or polyester, cross-linking agent, and blowing agent. A gelling and blowing catalyst can also be added to the B-side to control reaction speeds and effect final product quality.

In at least one aspect of the present invention, the isocyanate-reactant component comprises a modified vegetable oil. Any suitable bio-based oils, particularly vegetable oils, through which air has been passed to remove impurities, functionalize the oil with hydroxyl(—OH) groups and to thicken the oil may be used in the practice of the present invention. Examples of suitable bio-based oils which may be used in the present invention after being blown include: vegetable or seed oils such as soy bean oil, rapeseed oil, or canola oil, peanut oil, cotton seed and/or sunflower oil, olive oil, grape seed oil, coconut oil, palm oil, linseed oil, and castor oil; fish oils and oils derived from animal fats. In certain embodiments, soy bean oil and castor oils are preferred. In other embodiments, soy bean oil is particularly preferred. Such blown oils are described in U.S. Pat. Nos. 6,180,686 and 6,624,244 and are commercially available under Urethane Soy Systems Company (USSC) under the name SoyOyl®. In at least one embodiment, SoyOyl® P38N is a preferred soy-based polyol.

In at least one embodiment, the blown vegetable oil comprises 100 percent of the isocyanate-reactive component. In other embodiments, the isocyanate-reactive component is a blend of blown vegetable oil and petrochemical-based isocyanate-reactive component. In these embodiments, the vegetable polyol may include between 0.5 and 75 percent weight percent, more preferably 5 to 50 weight percent, and most preferably 30 to 45 weight percent, of the isocyanate-reactive component, based on the total weight of the isocyanate-reactive component.

Petrochemical-based isocyanate reactive components suitable for use with the present invention include compounds having a number average molecular weight of from 400 to 10,000, preferably from 470 to 8,000, most preferably from 1,000 to 6,500 and contain amino groups, hydroxyl groups, thiol groups, or a combination thereof. These isocyanate-reactive compounds generally contain from 1 to 8 isocyanate-reactive groups, preferably from 2 to 6 isocyanate-reactive groups. Suitable such compounds include polyethers, polyesters, polyacetals, polycarbonates, polyesterethers, polyester carbonates, polythioethers, polyamides, polyesteramides, polysiloxanes, polybutadienes, and polyacetones. Particularly preferred isocyanate-reactive compounds contain 2 to 4 reactive amino or hydroxyl groups.

Suitable hydroxyl-containing polyethers are known and commercially available. Such polyether polyols can be prepared, for example, by the polymerization of epoxides such as ethylene oxide, propylene oxide, butylene oxide, tetrahydrofuran, styrene oxide, or epichlorohydrin, optionally in the presence of BF₃, or by chemical addition of such epoxides, optionally as mixtures or successively, to starting components containing reactive hydrogen atoms, such as water, alcohols, or amines. Polyethers that contain predominantly primary hydroxyl groups (up to 90% by weight, based on all of the hydroxyl groups in the polyether) are preferred. Particularly preferred polyethers include polyoxyalkylene polyether polyols, such as polyoxyethylene diol, polyoxypropylene diol, polyoxybutylene diol, and polytetramethylene diol.

Hydroxyl-containing polyesters are also suitable for use in the isocyanate-reactive component. Suitable hydroxyl-containing polyesters include reaction products of polyhydric alcohols (preferably diols), optionally with the addition of trihydric alcohols, and polybasic (preferably dibasic) carboxylic acids. Instead of free polycarboxylic acids, the corresponding polycarboxylic acid anhydrides or corresponding polycarboxylic acid esters of lower alcohols or mixtures thereof may be used for preparing the polyesters. The polycarboxylic acids may be aliphatic, cycloaliphatic, aromatic, or heterocyclic and may be substituted, e.g., by halogen atoms, and/or unsaturated.

Suitable polyacetals include compounds obtained from the condensation of glycols, such as diethylene glycol, triethylene glycol, 4,4′-dihydroxydiphenylmethane, and hexanediol, with formaldehyde or by the polymerization of cyclic acetals, such as trioxane.

Suitable polycarbonates include those prepared by the reaction of diols, such as 1,3-propanediol, 1,4-butanediol, 1,6-hexanediol, diethylene glycol, triethylene glycol, tetraethylene glycol, or thiodiglycol, with phosgene or diaryl carbonates such as diphenyl carbonate.

Suitable polyester carbonates include those prepared by the reaction of polyester diols, with or without other diols such as 1,3-propanediol, 1,4-butanediol, 1,6-hexanediol, diethylene glycol, triethylene glycol, tetraethylene glycol, or thiodiglycol, with phosgene, cyclic carbonates, or diaryl carbonates such as diphenyl carbonate. Suitable polyester carbonates more generally include compounds such as those disclosed in U.S. Pat. No. 4,430,484.

Suitable polythioethers include the condensation products obtained by the reaction of thiodiglycol, either alone or with other glycols, formaldehyde, or amino alcohols. The products obtained are polythio-mixed ethers, polythioether esters, or polythioether ester amides, depending on the components used.

Suitable polyester amides and polyamides include, for example, the predominantly linear condensates prepared from polybasic saturated and unsaturated carboxylic acids or the anhydrides thereof and polyvalent saturated or unsaturated amino alcohols, diamines, polyamines, and mixtures thereof.

In at least one embodiment, a combination of Multranol 3901, Multranol 5168 and Multranol 9199 comprises the preferred petrochemical based-polyols.

Suitable crosslinking agents or chain extenders which may be included in the isocyanate-reactive component of the present invention generally have a molecular weight of less than 399 and a functionality of from 2 to 6 (preferably 2 to 4). Chain extenders generally have a functionality of 2 and crosslinkers generally have a functionality greater than 2. Such compounds typically contain hydroxyl groups, amino groups, thiol groups, or a combination thereof, and generally contain 2 to 8 (preferably 2 to 4) isocyanate-reactive hydrogen atoms.

If present, the chain extender and/or cross-linking agent is generally included in the isocyanate-reactive component in an amount of from 0.10 to 10% by weight, based on total weight of isocyanate-reactive component, preferably, from 0.2 to 1% by weight, most preferably from 0.30 to 0.5% by weight.

Any suitable cross-linking agent and/or chain extender may be used. Suitable examples include, hydroxyl-containing chain extenders and crosslinkers such as glycols and polyols, hydroxyl-containing polyethers having a molecular weight of less than 399, such as, polyoxyalkylene polyether polyols and amine chain extenders and/or cross-linking agents preferably containing exclusively aromatically bound primary or secondary (preferably primary) amino groups and preferably also contain alkyl substituents. In at least one embodiment, the tri-functional diethanolamine (DEOA) is a particularly suitable cross-linking agent.

If present, the catalyst is generally included in the isocyanate-reactive component in an amount of from 0.01 to 10% by weight, based on total weight of isocyanate-reactive component, preferably from 0.1 to 3% by weight, most preferably from 1 to 2% by weight.

Suitable catalysts include tertiary amines and metal compounds known in the art. Suitable tertiary amine catalysts include triethylamine, tributylamine, N-methylmorpholine, N-ethylmorpholine, N,N,N′,N′-tetramethylethylene diamine, pentamethyldiethylene triamine, and higher homologs, 1,4-diazabicyclo[2.2.2]octane, N-methyl-N′-(dimethylaminoethyl)piperazine, bis(dimethylaminoalkyl)piperazines, N,N-dimethylbenzylamine, N,N-dimethylcyclohexylamine, N,N-diethylbenzylamine, bis(N,N-diethylaminoethyl)adipate, N,N,N′,N′-tetramethyl-1,3-butanediamine, N,N-dimethyl-.beta.-phenylethylamine, 1,2-dimethylimidazole, 2-methylimidazole, monocyclic and bicyclic amidines, bis(dialkylamino)alkyl ethers (U.S. Pat. No. 3,330,782), and tertiary amines containing amide groups (preferably formamide groups).

Suitable catalysts also include certain tertiary amines containing isocyanate reactive hydrogen atoms. Examples of such catalysts include triethanolamine, triisopropanolamine, N-methyldiethanolamine, N-ethyldiethanolamine, N,N-dimethylethanolamine, their reaction products with alkylene oxides (such as propylene oxide and/or ethylene oxide) and secondary-tertiary amines.

Other suitable catalysts include organic metal compounds, especially organic tin, bismuth, and zinc compounds. Suitable organic tin compounds include those containing sulfur, such as dioctyl tin mercaptide and, preferably, tin(II) salts of carboxylic acids, such as tin(II) acetate, tin(II) octoate, tin(II) ethylhexoate, and tin(II) laurate, as well as tin(IV) compounds, such as dibutyltin dilaurate, dibutyltin dichloride, dibutyltin diacetate, dibutytin maleate, and dioctyltin diacetate. Suitable bismuth compounds include bismuth neodecanoate, bismuth versalate, and various bismuth carboxylates known in the art. Suitable zinc compounds include zinc neodecanoate and zinc versalate. Mixed metal salts containing more than one metal (such as carboxylic acid salts containing both zinc and bismuth) are also suitable catalysts.

Any of the above-mentioned catalysts may, of course, be used as mixtures.

In at least one embodiment, a mixture of catalysts comprising NIAX A-1 (bis-dimethyl aminoethyl ether), NIAX A-4 (non-reactive tertiary amine/amide polyakylene oxide alcohol mixture) and Dabco 33-LV (33% triethyl-enediamine in titratable 67% dipropylene glycol) is preferred.

Suitable blowing agents for use in the preparation of polyurethane foams include water and/or readily volatile organic substances. Organic blowing agents include low-boiling hydrocarbons (such as butane, hexane, or heptane), fluorocarbons, methylene chloride, carboxylic acids, as well as carbon dioxide generating agents that generate carbon dioxide typically by the hydrolysis of isocyanate groups. A blowing effect may also be obtained by adding compounds which decompose at temperatures above room temperature and thereby give off gases such as nitrogen (for example, azo compounds such as azoisobutyronitrile or carbon dioxide (such as dimethyl dicarbonate).

If present, the blowing agent is generally included in the isocyanate-reactive component (polyol) in an amount of from 1.0 to 10% by weight, based on total weight of isocyanate-reactive component, preferably from 3.0 to 6% by weight, most preferably from 2 to 5% by weight.

A combination of silicone surfactants is included in the isocyanate-reactive component in an amount of from 0.1 to 10.0 by weight based on the total weight of isocyanante-reactive component, preferably from 0.5 to 2.25 by weight, and most preferably from 1.0 to 2.0 by weight. In at least one embodiment, the combination of silicone surfactants comprises a first silicone surfactant and a second silicone surfactant. In at least one embodiment, the first silicone surfactant is a silicone glycol copolymer having a viscosity at 25° C. of 960 cps. In at least one embodiment, the second silicone surfactant is a silicone surfactant.

The combination of silicone surfactants is present in the isocyanate-reactive component in an amount which will render a stable and usable cellular foam that is suitable for use in automotive interior applications. In at least one embodiment, the combination of silicone surfactants is provided in an amount such that the cellular material has a density of greater than 35 kilograms/m³, a compression set at 50 percent deflection of less than 14 percent, a tensile strength of greater than 110 kPa, an elongation of greater than 95 percent and a tear resistance of greater than 170 N/m.

In at least one embodiment, the first surfactant comprises 0.5 to 15 percent by weight of the combination of silicone surfactants, more preferably 1 to 7.5 percent by weight, and most preferably 3 to 5 percent by weight, with the second surfactant and/or the second surfactant and at least one other silicone surfactant comprising the remainder of the combination of silicone surfactants. In at least one embodiment, the combination of silicone surfactants comprises Dabco 5943 and Tegostab 8715LF. Tegostab 8715LF can be referred to as a low-fog silicone surfactant. Other examples of such surfactants are Tegostab 4113 LF, and 8729 LF.

Other additives which may optionally be included in the isocyanate-reactive component of the invention and include, for example, flame retardants, internal mold release agents, acid scavengers, water scavengers, cell regulators, pigments, dyes, UV stabilizers, plasticizers, fungistatic or bacteriostatic substances, and fillers.

The storage-stable isocyanate-reactive compositions of the present invention can be prepared by mixing the individual components in any order but are preferably prepared by combining the polyols first and subsequently adding any catalyst, blowing agent, filler, water, etc. to the polyol mixture.

The isocyanate-reactive compositions of the present invention can be used for the preparation of various urethane-based products. As used herein, the term “polyurethane” also refers to polyureas and polyurethane polyurea hybrids.

When preparing polyurethanes according to the invention by the isocyanate addition reaction, the isocyanate-reactive component is allowed to react with an organic polyisocyanate. Suitable polyisocyanates are known in the art. Suitable polyisocyanates can be unmodified isocyanates, modified polyisocyanates, or isocyanate prepolymers. Suitable organic polyisocyanates include aliphatic, cycloaliphatic, araliphatic, aromatic, and heterocyclic polyisocyanates of the type described, for example, by W. Siefken in Justus Liebigs Annalen der Chemie, 562, pages 75 to 136. Examples of such isocyanates include those represented by the formula
Q(NCO)ₙ
in which n is a number from 2 to 5 (preferably 2 to 3) and Q is an aliphatic hydrocarbon group containing 2 to 18 (preferably 6 to 10) carbon atoms, a cycloaliphatic hydrocarbon group containing 4 to 15 (preferably 5 to 10) carbon atoms, an araliphatic hydrocarbon group containing 8 to 15 (preferably 8 to 13) carbon atoms, or an aromatic hydrocarbon group containing 6 to 15 (preferably 6 to 13) carbon atoms.

In general, it is preferred to use readily available polyisocyanates, such as 2,4- and 2,6-toluene diisocyanates and mixtures of these isomers (“TDI”); MDI; and polyisocyanates containing carbodiimide groups, urethane groups, allophanate groups, isocyanurate groups, urea groups, or biuret groups (“modified polyisocyanates”).

It is, of course, also possible to use isocyanate prepolymers prepared by reaction of any of the above polyisocyanates with a sub-stoichiometric amount of isocyanate-reactive compound. For instance, some or all of the soy-based polyol, and/or other polyol, can be reacted with the polyisocyanate.

It is, of course, likewise also possible to use polyol prepolymers by reaction of any of the above isocyanate-reactive compound, such as polyol, with a sub-stoichiometric amount of isocyanate.

The cellular foam products of the present invention are provided by reacting the isocyanate-reactive components (B-side reactants) with the isocyanate components (A-side reactants) in a manner that is well known in the art. Equipment useful for conducting the reaction process of the present invention is also well known to those skilled in the art.

When carrying out a reaction of an isocyanate-reactive composition according to the invention with an isocyanate, the quantity of isocyanate component should preferably be such that the isocyanate index is from 80 to 130, preferably from 90 to 120, even more preferably from 95 to 120, and most preferably 100 to 110. By “isocyanate index” is meant the quotient of the number of isocyanate groups divided by the number of isocyanate-reactive groups, multiplied by 100.

The polyurethane foams produced in accordance with the present invention are flexible foams and may have densities of from 30 to 60 kg/m³, preferably from 35 to 55, most preferably from 35 to 50, and utmost preference of 30 to 45.

For use with interior vehicle applications, the polyurethane foam of the present invention should have at least one, and preferably all, of the following characteristics, a density greater than 35 kilograms/m³, a compression set at 50 percent deflection of less than 14 percent, a tensile strength of greater than 110 kPa, an elongation of greater than 95 percent, and a tear resistance of at least 170 N/m.

In certain embodiments, for use with interior vehicle applications, the polyurethane foam of the present invention may have at least one, and preferably all, of the following characteristics, a density greater than 40 kilograms/m³, a compression set at 50 percent deflection of less than 12 percent, a tensile strength of greater than 120 kPa, an elongation of greater than 100 percent, and a tear resistance of at least 185 N/m.

In certain other embodiments, for use with interior vehicle applications, the polyurethane foam of the present invention may have at least one, and preferably all, of the following characteristics, a density greater than 45 kilograms/m³, a compression set at 50 percent deflection of less than 10 percent, a tensile strength of greater than 130 kPa, an elongation of greater than 105 percent, and a tear resistance of at least 200 N/m. A polyurethane foam with this set of characteristics may be suitable for use as a seat cushion.

In other embodiments, the polyurethane foam may have at least one, and preferably all, of the following characteristics, a density of greater than 45 kilograms/m³, a compression set at 75 percent deflection of less than 25 percent, a tensile strength of greater than 80 kPa, an elongation of greater than 80 percent, and a tear resistance of at least 180 N/m. A polyurethane foam having these characteristics may be suitable for use as a head rest.

Foam density can be measured in accordance with the following procedure: foam blocks with dimensions of 1 inch by 2 inch by 2 inch are cut from the center of the foam using a standard band saw. Samples are weighed and measured with a dial gauge to calculate the density in kilograms/m³. Typically, four blocks per formulation are measured and averaged to determine a density measurement.

Tensile strength and percent elongation can be measured in accordance with ASTM D3574. Specimens with one inch grip width and 5.5 inches in total length are stamped from 12.5 millimeter thick slabs using a tensile bar die. An Instron Model 5565 with 500N load cell in a tensile geometry is used to pull the samples at a cross-head velocity of 50 mm/min. Tensile strength and percent elongation values are recorded for approximately five samples per set.

Compression set for constant deflection can be measured in accordance with the following procedures. Compression set value can be determined according to ASTM D3574 standard. Foam samples are cut from the center of the molded foam into one inch by two inch by two inch blocks and measured with a dial gauge. Four samples per trial can be compressed between two parallel plates with 50 percent deflection and heated in an oven for 22 hours at 70° C. After heat conditioning, the dimensional measurements can be taken again and compression set can be calculated using the following equation:
C_{d}=[(t₀−t_{f})/t₀]×100 (Equation 1)
where C_{d} is the compression set at constant deflection, t_{O} is the original thickness and t_{f} is the final thickness of the sample.

The practice of this invention may be further appreciated by consideration of the following, non-limiting examples, and the benefits of the invention may be appreciated by the examples set forth below.

### EXAMPLE

An A-side reaction mixture is reacted with a B-side reaction mixture to form a soy-based polyurethane foam. The B-side components are blended with a 2300 rpms stirring head mixer before adding the A-side components. After the A-side components have been added, the stirring continues for 10 seconds. The viscous blend is then poured into a heated aluminum box, such as one that is 15 inches by 15 inches by 4 inches, and sealed with a lid and clamps. The foam is cured at 70° C. for 10 minutes, followed by room temperature curing for 48 hours before sectioning.

The A-side components and B-side components are shown below in Table 1.

TABLE 1

| | |
|---|---|
| Component | Parts By Weight |

B-side Components:

| | |
|---|---|
| SoyOyl ® P38N | 36 |
| Multranol 3901 | 22 |
| Multranol 5168 | 32 |
| Water | 3.35 |
| DEOA | 0.35 |
| Tegostab 8715LF | 1.38 |
| Dabco 5943 | 0.06 |
| NIAX A-1 | 0.17 |
| NIAX A-4 | 0.5 |
| Dabco 33-LV | 0.75 |
| Multranol 9199 | 3.44 |
| Dabco 5943 | 0.06 |

A-side Component:

| | |
|---|---|
| Mondur ® MRS-20 | 100 |

SoyOyl® P38N is a two functional polyol made from unmodified soy bean oil. The SoyOyl® P38N has an equivalent weight of 1,020, a hydroxyl value (ASTM E222-00) of 52-56 mg KOH/g, an acid value (ASTM E222-00) of 2-4 mg KOH/g, and a viscosity (ASTM D4878-03) of 2500-4000 cps. SoyOyl® P38N is available from Urethane Soy System Company (USSC).

Multranol 3901 is polyoxypropylene triol modified with EO (ethylene oxide). It has an equivalent weight of 2003.6, a functionality of three, molecular weight of 6,000, a hydroxyl number of 26-30 mg KOH/g, an acid number of 0.10 mg KOH/g, and a viscosity at 25° C. of 1,020-1,220 mPa·s. Multranol 3901 is available from Bayer.

Multranol 5168 is polypropylene oxide diol modified with EO. It has an equivalent weight of 2,003.6, a functionality of two, a molecular weight of 4,000, a hydroxyl number of 25-31 mg KOH/g, and a viscosity at 25° C. of 700-960 mPa·s. Multranol 5168 is available from Bayer.

The water is used as the blowing agent.

The DEOA is diethanolamine having an OH number of 1,601, an equivalent weight of 35, a functionality of three and is available from Aldrich.

The Tegostab 8715LF is a silicone surfactant having a viscosity at 25° C. of 85-135 mPa·s and is available from the Goldschmidt Chemical Corporation division of Degussa in Hopewell, Va.

Dabco DC5943 is a silicone glycol copolymer surfactant available from Air Products and has a viscosity at 25° C. of 960 cP.

NIAX A-1 is a catalyst containing 70 percent bis(2-dimethylaminoethyl) ether with 30 weight percent dipropylene glycol. The NIAX A-1 has a viscosity at 20° C. of 4.1 cP. The NIAX A-1 is available from GE Silicones.

NIAX catalyst A-4 is an amine catalyst. The NIAX A-4 catalyst has a viscosity at 20° C. of 106 cP. The NIAX A-4 is available from GE Silicones.

Dabco 33-LV is a catalyst comprising a solution of 33 percent triethylenediamine and 67% dipropylene glycol. The Dabco 33-LV has a viscosity at 25° C. of 125 centipoise and an OH number of 560 mg KOH/g. The Dabco 33-LV catalyst is available from Air Products.

Multranol 9199 has an OH number of 37, an equivalent weight of 1,516, a functionality of three and a molecular weight of 4,525. Multranol 9199 is available from Bayer.

Mondur® MRS-20 is a low functionality polymeric diphenylmethane diisocyanate (PMDI). The MRS-20 has an NCO content of 32.4 weight percent and a viscosity at 25° C. of 25 mPa·s. The Mondur® MRS-20 is available from Bayer.

The resulting foam has the following properties shown below in Table 2.

TABLE 2

| | Compression Set | | | |
|---|---|---|---|---|
| Density | at 50% | Tensile | Elongation | Tear Resistance |
| (kg/m³) | Deflection | Strength kPa | (%) | N/m |
| 37 | 11 | 113 | 100 | 190 |

While the best mode for carrying out the invention has been described in detail, familiar with the art to which this invention relates will recognize various alternative designs embodiments for practicing the invention as defined by the following claims.

1. A cellular material comprising the reaction product of:
soy-based polyol;
isocyanate;
blowing agent;
cross-linker; and
a combination of silicone surfactants.

2. The cellular material of claim 1 wherein the reaction product further includes petroleum-based polyol.

3. The cellular material of claim 1 wherein the reaction product further includes one or more catalysts.

4. The cellular material of claim 1 wherein the combination of silicone surfactants is provided in an amount such that the cellular material has a density of greater than 35 kilograms/m³, a compression set at 50 percent deflection of less than 14 percent, a tensile strength of greater than 110 kPa, an elongation of greater than 95 percent and a tear resistance of greater than 170 N/m.

5. The cellular material of claim 1 wherein the combination of silicone surfactants is provided in an amount such that the cellular materials has a density of greater than 45 kilograms/m³, a compression set at 75 percent deflection of less than 25 percent, a tensile strength of greater than 80 kPa, an elongation of greater than 80 percent, and a tear resistance of at least 180 N/m.

6. The cellular material of claim 4 wherein the combination of silicone surfactants comprises a first surfactant comprising a silicone glycol copolymer.

7. The cellular material of claim 6 wherein the combination of silicone surfactants comprises a second surfactant comprising a low-fog silicone surfactant.

8. A method of making a cellular material, said method comprising reacting the following components together:
soy-based polyol;
isocyanate;
blowing agent;
cross-linker; and
a combination of silicone surfactants.

9. The method of claim 8 wherein the components further include petroleum-based polyol.

10. The method of claim 8 wherein the components further include one or more catalysts.

11. The method of claim 8 wherein the combination of silicone surfactants is provided in an amount such that the cellular material has a density of greater than 35 kilograms/m³, a compression set at 50 percent deflection of less than 14 percent, a tensile strength of greater than 110 kPa, an elongation of greater than 95 percent and a tear resistance of greater than 170 N/m.

12. The method of claim 11 wherein the combination of silicone surfactants comprises a first surfactant comprising a silicone glycol copolymer.

13. The method of claim 12 wherein the combination of silicone surfactants comprises a second surfactant comprising a low-fog silicone surfactant.

14. The method of claim 8 wherein the soy-based polyol comprises a vegetable oil.

15. A composition suitable for making a cellular material, the composition comprising:
soy-based polyol;
isocyanate;
blowing agent;
cross-linker; and
a combination of silicone surfactants.

16. The composition of claim 15 further including petroleum-based polyol.

17. The composition of claim 15 wherein the combination of silicone surfactants is provided in an amount such that a resultant cellular material has a density of greater than 35 kilograms/m³, a compression set at 50 percent deflection of less than 14 percent, a tensile strength of greater than 100 kPa, an elongation of greater than 95 percent and a tear resistance of greater than 170 N/m.

18. The composition of claim 17 wherein the combination of silicone surfactants comprises a first surfactant comprising a silicone glycol copolymer.

19. The composition of claim 18 wherein the combination of silicone surfactants comprises a second surfactant comprising a low-fog silicone surfactant.

20. The composition of claim 16 wherein components of the composition are present in the following amounts, based upon the total weight of the composition:

| Components | wt. % |
|---|---|
| soy-based polyol | 5-75 |
| petroleum-based polyol | 15-50 |
| isocyanate | 25-75 |
| blowing agent | 0.5-5.0 |
| cross-linker | 0.05-5.0 |
| first silicone surfactant | 0.005-0.25 |
| second silicone surfactant | 0.1-4.75 |
